(19) United States
(12) Patent Application Publication
(10) Pub. No.: US 2009/0072176 A1
(43) Pub. Date: Mar. 19, 2009

(54) Valve Device

(76) Inventors: Thomas Rosch, Linsengericht (DE); Bernhard Beck, Biebergemund (DE); Werner Hempel, Nidderau (DE)

Correspondence Address: BUCHANAN, INGERSOLL & ROONEY PC, POST OFFICE BOX 1404, ALEXANDRIA, VA, 22313-1404, US

(21) Appl. No.: 11/991,778

(22) PCT Filed: Sep. 20, 2005
(86) PCT No.: PCT/EP2005/010142

§ 371 Date: May 1, 2008

(51) Int. Cl. F16K 51/00

(52) U.S. Cl. 251/212

(57) ABSTRACT

The invention relates to a valve device, preferably for a line device or connecting device. Said valve device comprises a valve body that can be transferred from an open position to a closed position. Said valve body comprises movable sectored devices having sealing edges or sealing surfaces via which, in a closed position, a sealing contact of the sectored device to adjoining sealing edges or sealing surfaces can be established. The sectored devices can at least be in sections moved away in the radial direction from the centre axis when the valve body is transferred to the open position and release a flow area.

The invention relates to a valve device, preferably for a line device or connecting device, with a valve body that can be transferred from an open position to a closed position, in accordance with the introductory portion of claim 1.

Valve devices of this kind are already known from the state of the art and are used in a multitude of design variants, whereby some of the uses are in building services, machine construction and automobile manufacture. They thereby comprise a valve body variously equipped with regard to the shape, whereby this valve body can be transferred by means of an actuating device from an open position to a closed position and, in the closed position, can be brought to lie against a valve seat to interrupt the flow.

Valve devices of this type, particularly in the case of a small and compact construction, usually thereby present considerable flow resistance, because inside the valve device there results a narrowing of the flow area and, because of the abrupt diversion of the flow, swirling and the formation of turbulence result, as a result of which flow resistance is further increased. Such valve devices consequently represent non-optimal compromises with regard to their construction size and flow interference. This disadvantage occurs particularly in small straight-way valves that can be integrated within a line device or a quick coupling which, during a large portion of their operating time, do not obstruct the flow and are intended to interrupt the flow only under certain conditions (separation of the connection, accident, disturbance or the like).

The object of the invention is therefore to provide a valve device in accordance with the introductory portion of claim 1 that has a small and compact construction and that simultaneously allows low flow resistances and prevents negative interference with the flow path.

This object is solved according to the invention by a valve device of the type mentioned at the beginning whose valve body comprises movable sectored devices having sealing edges or sealing surfaces via which, in a closed position, a sealing contact of the sectored device to adjoining sealing edges or sealing surfaces can be established, whereby these sectored devices can at least be in sections moved away in the radial direction from the centre axis when the valve body is transferred to the open position and release a flow area.

An advantage of the present invention lies in the fact that a valve device of this type can advantageously be used as a straight-way valve in line devices and within line connectors, preferable quick connectors. Valve devices of this type are also particularly suitable as self-closing safety valves or check valves. One of the advantageous uses of valve devices of this type is in the automotive industry, in order to release or interrupt the fuel flow when engines that are connected to fuel lines for trial runs at the production site are to be separated from the fuel supply again after the trial run, in order to transport them to the production line for the intended installation and there, in turn, to connect them to a fuel line, or in order to be able to remove the engine from the vehicle or re-install it, e.g., during maintenance, replacement or repair work, without any fuel being able to leak from the fuel line. A further merit of the valve device according to the invention lies in the straight pathway through the valve device, which is not obstructed by a valve body and consequently offers better cleaning and probing possibilities. Even although the preceding advantages and use of the invention have been explained particularly with reference to the automotive industry, advantageous use of the invention is not restricted to this area, so that the invention can likewise display its favourable characteristics in other areas of machine construction, medical technology, construction, building services and industry.

In a further preferred embodiment, a sealing contact can be established between the sealing edges or sealing surfaces of adjacent sectored devices and the sealing edges or sealing surfaces that lie against one another in the closed state and that belong to adjoining sectored devices can be at least in sections moved away from one another in the circumferential direction when the valve body is transferred to the open position. The opening-side section of the valve body can open maximally in the case of such a structure of the valve body, said structure being technically easy to realise.

In a further preferred embodiment, it can be possible to bring the valve body with a plurality of sectored devices to lie, with an outer contour of the valve body, against a valve seat in a manner that forms a seal in the closed state, whereby it is possible simultaneously to achieve a tight seat of the closed valve body in the valve seat with the sealed closing of the sealing edges or sealing surfaces of the sectored devices.

In a further preferred embodiment, the valve body can be hollow, whereby the valve body in the closed state forms a closed hollow form in the direction of the opening end, said hollow form having an opening in the direction of a non-opening end of the valve body, and the sectored devices of said valve body forming sealing edges via which a sealing contact between the sectored devices can be established in the closed state. By means of such a hollow execution of the valve body, it is possible to obtain a larger flow area and therefore to reduce flow resistance.

In a further preferred embodiment, it can be possible to transfer the sectored devices from the open position to the closed position via an actuating device, as a result of which selective actuation of the sectored devices is made possible independently of, e.g., flow and pressure conditions.

In a further preferred embodiment, the actuating device can, at least in sections, be mechanically connected to the sectored devices, as a result of which the sectored devices can be actuated directly and at least without immediate interaction with another component, as a result of which the risk of wear or damage can be reduced.

In a further preferred embodiment, the actuating device can be mechanically unconnected to the sectored devices and can be movable relative to the sectored devices in the axial direction. Such an actuating device can, e.g., be moved against the valve body either from the direction of the opening end or the non-opening end of the valve body and cause this to close in a manner similar to the tongs of a conical clamping device or of a chuck.

In a further preferred embodiment, the sectored devices are movable relative to a valve seat in the axial direction, wherein the sectored devices can be moved radially towards one another and closed by sliding them against the valve seat and can be opened by moving away from the valve seat. By means of such an embodiment, it is possible, in a manner that is simple and technically elegant, to close the sectored elements by sliding them against the valve seat and to bring the valve body to lie against the valve seat so as to form a seal.

In a further preferred embodiment, it can be possible to close the sectored devices of the valve body by pulling the valve body into the valve seat, as a result of which the double movement, which brings the sealing edges of the sectored devices into a sealing contact and brings the valve body to lie against the valve seat in a sealing manner, allows coupling in a particularly simple and efficient manner with the movement of the force-diverting device.

In a further preferred embodiment, it can be possible to connect the valve body to the pull- and/or push-actuating device, via which the valve body can be moved relative to the valve seat. In the case of this embodiment, it is possible to couple the valve body and the pull- and/or push-actuating device, which can be executed together as a single piece or as a number of pieces, directly and so to provide a simple and reliable design.

In a further preferred embodiment, the valve body can have a plurality of flat surface elements on its outer side, as a result of which it is possible to produce simple mechanical linkage of the sectored devices, e.g., via hinged elements.

In a further preferred embodiment, the valve body can have on its outer side sub-areas in the shape of conical envelope sectors or truncated conical envelope sectors. As a result of the formation of a cone-shaped conical section, the valve body can produce a particularly simple and reliable sealing contact with the valve seat.

In a further preferred embodiment, the valve body can have ellipsoid, paraboloid or hyperboloid sub-areas on its outer side. Such a shaping presents itself, e.g., in order to open or close a valve with a short stroke movement of the pull-push actuating device, to increase the closing forces of the sectored devices or to make easier, make more difficult or prevent, depending on the formation of the contact angle between the valve body and the valve seat, the re-opening of the valve. Furthermore, such structuring of the valve body can allow optimisation of the aperture angle and flow area through the open valve body.

In a further preferred embodiment, the closed valve body can have two pyramid structures with the same base and connected to each another at the bases, whose one conical structure, arranged in the direction of the opening end, corresponds in its outer shape to a conical envelope and whose other conical structure, arranged in the direction of the non-opening end, corresponds in its outer shape to a truncated conical envelope, whereby the closed valve body is circular in the transversal cutting plane. This represents the geometrically simplest shaping for the valve body, simultaneously allowing a good fit of the closed valve body in the valve seat.

In a further preferred embodiment, the closed valve body can have two pyramidal structures with the same base and connected to each other at the bases, whose one pyramidal structure, arranged in the direction of the opening end, corresponds in its outer shape to a pyramidal envelope and whose other pyramidal structure, arranged in the direction of the non-opening end, corresponds in its outer shape to a truncated pyramidal envelope, whereby the closed valve body forms a regular polygon in the transversal cutting plane. This likewise very simple shaping appears advantageous if straight hinged axes are to be used for linkage of the sectored devices.

In a further preferred embodiment, the closed valve body can have, at least at the closed pointy end of the pyramid vertex of the pyramid lying in the direction of the opening end, sectored devices that can open in the radial direction, whereby these sectored devices form sealing edges which embrace at least the outer edges of the pyramid arranged in the direction of the opening end. The conducting of the sealing edges at least in sections along the outer edges of the pyramids represents a particularly expedient structure when the valve body has a pyramidal shaping, in which the sectored elements can be linked by means of straight-running hinged elements and so it is possible to achieve clean conducting of the sectored devices and a good sealed closure of the sealing edges.

In a further preferred embodiment, the pyramidal structures can be constructed from straight, three-dimensional simplices or tetrahedrons and can form, in the transversal cutting plane, an equilateral triangle, which allows particularly simple and efficient shaping of the sealing body and very good self-centring characteristics. Such a valve body is furthermore simultaneously syngonally adjusted or aligned in the polygonal valve seat in the rotational direction.

In a further preferred embodiment, the rotationally-symmetrical or polyhedric, axially-symmetrical valve body can have a transversal equatorial plane in which its transversal cut forms a maximum area from which the valve body tapers essentially conically in the closing direction. As a result of such shaping of the valve body, the valve body itself can simultaneously and without additional devices form a sealing cone and can produce the radial closing force needed for the closing movement of the sectored devices when the valve body is pulled into the valve seat.

In a further preferred embodiment, the valve body can circumscribe a circle in the transversal equatorial plane in which its transversal cut has a maximum area, whereby the valve body tapers essentially conically from this circle in the closing direction and transforms into a polygon in the transversal cutting plane. Such shaping simultaneously allows the advantages of a radial valve seat and also linear hinged elements.

In a further preferred embodiment, the valve body can have an odd number of sectored devices, preferably three sectored devices that form equal sector angles, preferably 120° angles, from the centre axis outwards, as a result of which better self-centring of the sectored devices can be achieved in the closed state.

In a further preferred embodiment, the valve body can comprise at least one base element to which the sectored devices are linked. In this way, a simple and reliable design of the linkage of the sectored devices is possible, whereby the sectored devices are individually connectable to the base element and so reliably held and guided.

In a further preferred embodiment, the sectored devices can be connected to the base element of the valve body by means of hinges, preferably foil hinges, or bending sections and the valve body can preferably be formed as a single piece. Such a design is particularly advantageous with respect to design and manufacture and, in the event of foil hinges or bending sections, can possibly allow manufacture of the entire valve body in just one operational step, e.g., in an injection moulding procedure.

In a further preferred embodiment, the valve body can have different materials in different sections, and preferably it can be manufactured in a multi-component moulding procedure. In particular, this can be brought about by sandwich moulding procedures or sandwich pressing procedures, or corresponding sintering procedures or coextrusion, coating or laminating procedures. In this way, the valve body can be optimally adapted, for example, to the various mechanical requirements of the various functional sections, as a result of which such a valve body is particularly suitable for more demanding requirements.

For example, it is also conceivable to provide the valve body with sliding or abrasion-resistant coatings or bending-resistant laminations or to equip moving or sealing sections with the materials particularly suited for fulfilling the specific requirements.

In a further preferred embodiment, the valve body can have a material in the linkage and bending area of the sectored devices that has greater elasticity and/or a lower modulus of elasticity than at the adjoining areas of the valve body, as a result of which this area can be particularly adapted to the bending load during valve actuation.

In a further preferred embodiment, the valve body can have a sealing material in the area of the sealing edges of the sectored devices. In this way, for example, it is possible to create sealing areas between the sectored devices, said sealing areas being particularly reliable at sealing, adaptable, flexible, mediophobic with respect to the media that flow through the valve area and/or wear-resistant.

In a further preferred embodiment, the valve body can have a sealing material in the valve seat area of the sectored devices. In this way, it is possible, for example, to create a sealing area between the valve body and the valve seat that is particularly reliably sealing, adaptable, flexible, mediophobic with respect to the media flowing through the valve area and/or wear-resistant.

In a further preferred embodiment, the sectored devices can be pre-tensed in the open position, as a result of which reliable and maximum opening of the sectored devices and consequently release of the full flow area can be ensured, independently of pressure conditions on either side of the valve device.

In a further preferred embodiment, the bending sections can preferably have a three-dimensional shape, whereby the material elasticity can be used for pre-tensing the sectored devices. By means of such an execution, provision of the pre-tensing is possible solely on the basis of the material characteristics and shaping, without additional manufacturing effort.

In a further preferred embodiment, the pull- and/or push-actuating device can have spring-like elastic characteristics and be provided for the purpose of acting upon the valve body in the closing direction of the same with a restoring force and transferring the valve body from the open position to the closed position when the end section of the line device or the second connecting device is removed from the connecting area of the valve housing. For example, this could be accomplished by a pull- and/or push-actuating device that consists of a highly-elastic metallic or polymer material, whereby it acts as a spring element and, for example, leads, by means of suitable contact areas within the flow channel, against which the pull- and/or push-actuating device supports itself, to a restoring movement of the valve body via the spring element's endeavour to return to its original shape. It would consequently be conceivable, for example, to execute the pull- and/or push-actuating devices as a section spring or coil spring or to integrate such a spring in the pull- and/or push-actuating device. In this way, it can be ensured by the design that immediate active closing of the valve device occurs when the end section of the line device is removed, regardless of pressure and flow conditions in the line devices connected to the valve device. The spring-like elastic execution of the pull- and/or push-actuating device proposed here makes it possible to guarantee the previously mentioned function without using additional components.

In a further preferred embodiment, the valve device can comprise a restoring device which acts upon the valve body in the closing direction of the same with a restoring force and which is provided for transferring the valve body from the open position to the closed position when the end section of the line or the second connecting device is removed from the connecting area of a coupling housing. An independent device or a component section, which is not, or not primarily, simultaneously provided for the pressure transfer, is responsible and optimised here for the restoring function. In this way, the design can ensure particularly reliably that, regardless of pressure and flow conditions in the line devices connected to the valve device, immediate, independent closing of the valve device is brought about when the end section of the line device or the second connecting device is removed and that no leakage occurs.

In a further preferred embodiment, the restoring device can be a coil spring that allows a large restoring path and particularly space-saving installation with simultaneously good positioning options.

In a further preferred embodiment, the restoring device can be a tension spring, which can be used in a multitude of variants of the coupling in accordance with the invention as a particularly universally usable restoring device regardless of the design of the pull- and/or push-actuating device.

In a further preferred embodiment, the coil spring can be arranged within the flow channel of the housing, enclosing at least sections of the pull- and/or push-actuating device, between the inner wall of the housing and the pull- and/or push-actuating device, as a result of which a particularly compact construction results, with simultaneous joint use of the compression spring as a guide mechanism for the pull- and/or push-actuating device.

In a further preferred embodiment, the coil spring can be a compression spring and can be spannable between a stopping element mechanically connected to the pull- and/or push-actuating device and a housing-side support lying axially at a distance to this stopping element and closer to the valve body with respect to this stopping element in the flow direction, whereby the valve body can be transferred to the closed position by a stroke via the pull- and/or push-actuating device and the compression spring can be pressure loaded when the valve is transferred to the closed position. Such an arrangement allows a particularly expedient solution with an elegant design for using the pull- and/or push-actuating device for actuating the valve body in both directions, i.e., in the opening direction and in the closing direction, whereby the pull- and/or push-actuating device can be used as a push-pull element.

In a further preferred embodiment, the housing-side support of the compression spring can be arranged adjacent to the valve seat, which in many cases allows a more compact design with simultaneous stabilisation of the pull- and/or push-actuating device.

In a further preferred embodiment, the valve body can be enclosed by a protective sleeve in the radial direction. By means of such a protective sleeve, which can be formed in a single piece with the housing, integrated into the line device connected to the valve side or connected to the housing in such a way that it can be removed from the same for, e.g., maintenance work, it is possible reliably to protect the valve body against damages during assembly or during use.

In a further preferred embodiment, the protective sleeve can essentially completely surround the valve body, at least in its closed state, in the radial direction, as a result of which there is usually sufficient dimensioning for effective protection of the valve body.

In a further preferred embodiment, the protective sleeve can be undetachably connected to the valve housing and preferably is formed with the valve housing as a single piece. In this case, loss and, where applicable, also unintentional disconnection of the protective sleeve during assembly and use can be reliably avoided. This can be brought about by suitable mechanical precautions, or, if removal of the protective sleeve, for example, during assembly and maintenance work, is not required, more economically and more simply, by an integral connection between the protective sleeve and the valve housing, which can be most economically achieved by one-piece execution of the two aforementioned devices.

The developments of the invention cited in the preceding represent only a selection of suitable design possibilities of the object of the invention that are laid down in the individual dependent claims. These special design possibilities can be applied individually or, as far as technically possible and expedient, also in a combination of a number of the previously mentioned design possibilities with a valve device in accordance with claim 1, as is apparent from the corresponding references back in the dependent claims.

In the following, the invention is explained in more detail by way of example using a preferred embodiment in connection with the associated figures. Shown are:

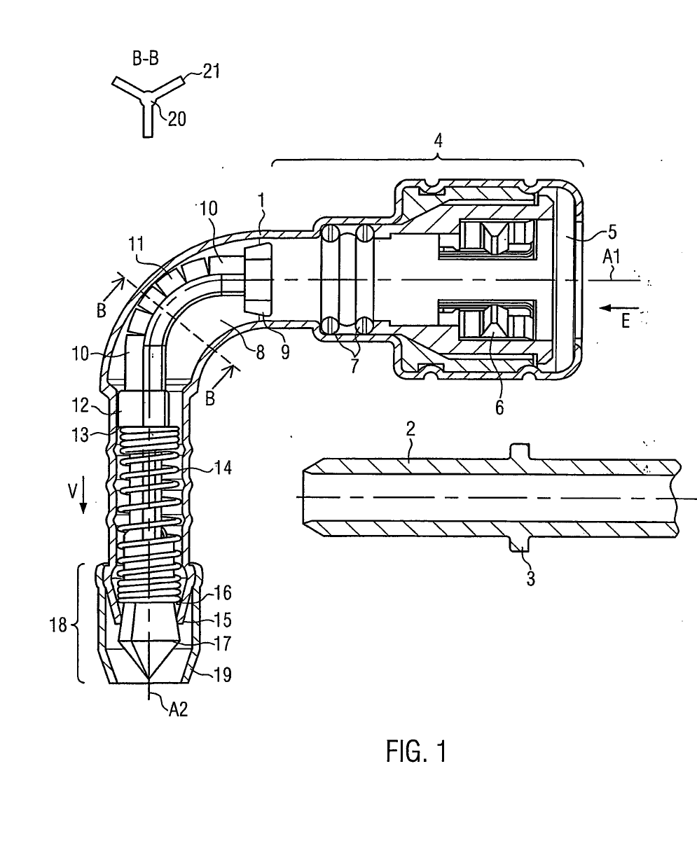

FIG. 1 the schematic depiction of a median cut in the axial plane through a quick connector with uncoupled line stub and closed valve;

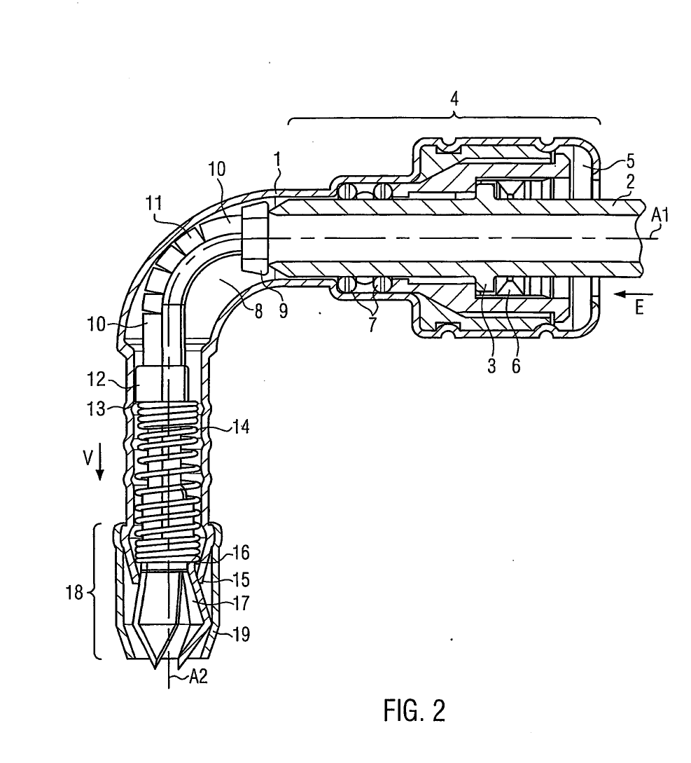

FIG. 2 the schematic depiction of a median cut in the axial plane through a quick connector with plugged-in line stub and open valve;

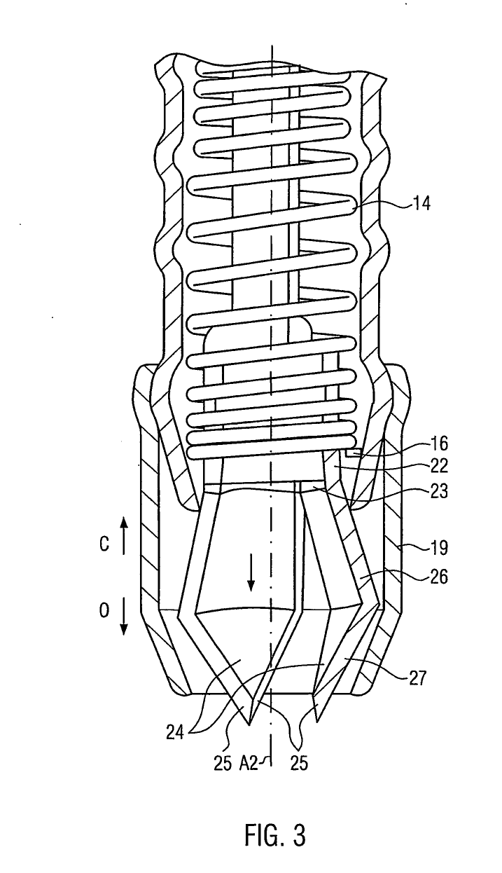

FIG. 3 the schematic depiction of a median cut in the axial plane through the valve area of a quick connector with plugged-in line stub and open valve.

FIG. 1 shows a quick connector or a quick coupling with a coupling housing 1 for connecting a line end section or a line stub 2 with an attachment collar 3 running around the circumference, in which the line end piece 2 is decoupled and the valve is located in the closed position.

The coupling housing 1 has a straight axis section, the insertion axis A1, which comprises the connection section 4 on the connection end side end, attached to this in the insertion direction E a curved section that describes a 90° bend and that on the valve side, in turn, transforms into a straight axis section, the valve axis A2, and ends in the valve section 18. The coupling housing 1 is hollow with a flow channel 8 going through it, said flow channel being closed in the valve area (valve section 18) by the valve body 17 in the closed position.

The connection section 4 of the coupling housing 1 comprises a retaining opening 5 for axial insertion in direction E of the line stub 2 of a line as well as a connecting device 6, by which the line stub 2 can be arrested, as well as a sealing ring 7, arranged behind this in the insertion direction E, by means of which the mechanically arrested line stub 2 can be hydraulically or pneumatically connected to the flow channel 8 and sealed against liquids and/or gases with respect to the surroundings.

On the valve end side and the end of the connection section 4 opposite the retaining opening 5 in the axial direction, a locating ring 9 is arranged such that a medium can flow through it in the axial direction, said locating ring being connected to a pressure transfer device 10 in the manner of a pressure plunger. The pressure transfer device 10 in the manner of a plunger hereby is executed from a flexible, media-resistant plastic and has, in a section adjacent to the locating ring 9, a flexible plunger section 11 for diverting the thrust. To increase flexibility, this flexible plunger section 11 has cuts running transversally on the outer side of the curve, said cuts running from the envelope line on the outer side of the curve in the direction of the plunger centre axis. In this embodiment, the plunger 10 itself shows a three-blade profile in the transversal cutting plane B-B, consisting of a central thrusting cylinder 20 with a small diameter, which is surrounded by three support and stabilisation ribs 21 arranged in radial planes and spaced apart from one another by equal distances around the circumference, each arranged rotated by 120° from the others in the transversal cutting plane.

At the valve end side direction V, a rigid section of the plunger 10 joins the flexible plunger section 11, said rigid section bearing a supporting element 12, which is, on the one hand, supported on the inner housing wall of the flow channel 8 and so stabilises the plunger 10 and that also simultaneously serves as a stopping element 13 for a compression spring 14.

The compression spring 14 here is tensed between the aforementioned stopping element 13 and a housing-side support 16 arranged adjacent to the valve seat 15, and serves as a restoring element that pulls the valve body 17 back into the valve seat 15 when the line stub 2 is decoupled and so closes the valve. The function of the valve unit is explained in more detail in association with FIG. 3.

The illustration furthermore shows a protective sleeve 19 that encloses the valve section 18 and so protects the valve device against damage during assembly and operation.

FIG. 2 shows the same embodiment as FIG. 1, but with inserted line stub 2 and open valve. The embodiment in FIG. 2 consequently corresponds to FIG. 1 with respect to its components, so that only the differences will be addressed, in order to avoid repetition.

FIG. 2 shows the line stub 2 in the arrested position within the connection section 4 of the coupling housing 1, whereby connecting devices 6 grasp behind the attachment collar 3 of the line stub 2 and so arrest it. By sliding the line stub 2 in, the stopping device 9 was slid further in direction E in the insertion direction of the line stub 2 in comparison to the state shown in FIG. 1, and the pressure was passed on to the plunger 10 so that it was slid further in the valve direction V. As a result of this movement, the movement of the stopping element 13 in the direction of the housing-side support 16 results in compression of the compression spring 14, which is spanned between the stopping element 13 and the housing-side support 16. At the same time, the valve body 17, which is connected to the pressure transfer device 10, is lifted out of the valve seat 15, as a result of which the flow channel 8 is opened on the valve side and a medium can flow through. The function of the valve unit is explained in more detail in FIG. 3.

When the connecting device 6 is loosened and the line stub 2 is pulled off, the restoring force of the compression spring 14 results in a reversal of the processes with an opposite movement of the pressure transfer device 10, which pulls the valve body 17 back into the valve seat 15, whereby the pressure transfer device 10 and the stopping device 9 move back into the positions shown in FIG. 1.

FIG. 3 shows a depiction of a detail of the valve section 18 in the open position and more precisely explains the function of the valve unit with valve body 17 through which a medium can flow, whereby reference numbers and statements of the other figures also apply to FIG. 3. In order to prevent repetitions, therefore, only new aspects that concern the configuration and function of the valve body are addressed.

The valve unit consists of a hollow valve body 17 through which a medium can flow, which is connected as shown at its cylindrical base body to three sectored devices 24 linked to it, whereby these sectored devices in the closed state have the form of a truncated cone 26 that is supported with the sharper end on the cylindrical base element 22 and that on the truncated end is connected to a cone 27 with the same base, inversely arranged, i.e. reflected at the cone base. The outer shape formed by the sectored devices 24 in the closed state is indicated in the further sequence as the double-conical structure 26, 27. This double-conical structure 26, 27 is separated into three double-conical structure sectors or sectored devices 24 by three radial planes offset from one another by angles of 120° and going out from the centre axis A2, said double-conical structure sectors or sectored devices being connected to the base element 22 via the bending section 23. These sectored devices 24 form sealing edges 25 at each adjacent sectored device 24 in the closed state. The double-conical structure 26, 27 of the closed valve body 17 is furthermore movable in the valve seat by the pull of the plunger 10 connected to the valve body, where the cone, formed by the truncated conic section 26, of this double-conical structure 26, 27 likewise produces a sealing contact with the valve seat 15. By lifting this double-conical structure 26, 27 from the valve seat 15, the bending sections 23 pre-tensed due to their three-dimensional structure automatically open and release the flow area.

Because of its shaping, the truncated conic section 26, linked to the base element 22, of the double-conical structure 26, 27 forms a cone, which can act upon the double-conical structure 26, 27 by pulling it into the valve seat 15 with a radial force and can seal it tightly, whereby at the same time, a tight fit of the double-conical structure 26, 27 is produced in the valve seat 15.

A valve design of this type makes it possible to manufacture a valve with a straight channel and particularly low flow resistance.

Further variants of the aforementioned first embodiment are possible and expedient, with the most important of these being shown by way of example in the following, with short explanations:

In place of a hollow valve body 17 as shown in the above embodiment, it can be expedient or necessary, e.g., for use in high-pressure blocking devices, to equip the valve body 17 with solid sectored devices 24, e.g., made of a metallic material, so that in the closed state, a large sealed closure is achieved between the sectored devices 24 and a high edge load on the sealing edges 25, as occurs in the case of a hollow sealing body 17, is avoided.

With regard to the actuating devices, various variants are possible, depending on the application area. It is consequently conceivable to design check valves or flow restrictors that manage without an actuating device and are opened and/or closed by flow conditions and/or pressure conditions. A further possibility would be, e.g., to connect parts of the actuating device to the sectored devices 24. In this case, it would be conceivable, for example, to integrate counter bearings, support sections or slide sections to the sectored devices 24, whereby said sectored devices could have a conical or curved profile, in order to achieve an improvement in the sealed closure or a reduction in wear, which can, however, possibly also serve to produce a sealing seat with the valve seat 15. In some cases, it can also be expedient to link a pull-push actuating device 10 directly to the sectored devices 24 and so carry out the valve closure without counter pressure of the valve body 17 against, for example, a valve seat 15 and possibly to attach the valve body 17 directly in the flow channel 8 in a sealing manner.

For a multitude of application cases, however, it is to be preferred to move the valve body 17 forward in the axial direction, for example, against an outer cone, in the opening direction O or closing direction C of the valve body 17, using the opening-side 27 or non-opening-side 26 section of the double-conical structure 26, 27 of the valve body 17, and so to produce a force directed radially inwards that produces a sealed radial closure of the sectored devices 24. It is particularly suitable in application cases in which a pull-push actuating device 10 is used that is connected to sections of the valve body 17 and that moves it to the closed position by tension, to use the non-opening conic section 26 of the valve body 17, which is pulled into the valve seat 15, to produce the closing force.

Various variants are also conceivable with respect to the geometric arrangements of the valve body 17, depending on the intended use and design type of the valve. For example, it can be expedient to provide the valve body 17 with a polyhedric structure, e.g., in order to attach this to the base body 22 of the valve unit by means of straight hinged elements 23, whereby a double pyramid structure of two three-dimensional simplices or tetrahedrons with the same base particularly presents itself, because in this case, the sectored devices 24 have the best self-centring characteristics and the number of hinges 23 is reduced. Such a valve body 17 is furthermore simultaneously (syngonally) adjusted or aligned in the (polygonal) valve seat 15 in the rotational direction.

With regard to sealing characteristics of the contact area between the valve seat 15 and valve body 17, on the other hand, a circular contact in the transversal cutting plane is advantageous. This can be achieved by means of a valve body 17 with double-conical structure 26, 27 or by the transition of the valve body 17 in the axial direction in the transversal cutting plane of a polygonal cross-section (in the hinged area) into a circular cross-section (in the area of the sealing seat of the valve body 17 in the valve seat 15). Such a valve body 17, which can, e.g., be produced as a single piece with the base element 22 of the valve body from a polymer material in an injection moulding procedure, can be equipped here with foil hinges or bending sections 23 and, during the manufacturing process, already be provided with an initial tension that opens the valve body 17 and so prevents sticking of the sectored devices 24 in the closed position after the lifting of the valve body 17 from the valve seat 15.

In some application cases, it can also be expedient to provide, in the median cutting plane, the valve body 17 in a curve progression instead of linearly-conically, as a result of which, for example, rotational bodies with other shapes and with non-double-conical-structure-shaped geometry can result, with, e.g., ellipsoid, paraboloid or hyperboloid sub-areas. Such shaping presents itself, e.g., in order to open or close a valve with a short stroke movement of the pull-push actuating device, to increase the closing forces of the sectored devices 24 or to make easier, make more difficult or prevent, depending on the formation of the contact angle between the valve body 17 and the valve seat 15, the re-opening of the valve. Furthermore, such a structuring of the valve body 17 can result in an optimised aperture angle and flow cross-section through the open valve body 17.

As a further variant, it is also conceivable not to connect the sectored devices 24 to a base element 22, but instead, e.g., to link them directly to the inner wall of the flow channel 8 or to the actuating device, in order in this way to eliminate the base element 22 or increase the flexibility of the sectored devices 24.

The coupling housing 1 of the valve device can contain, instead of a section already curved during the manufacturing process, a section that can be angled off or that is flexible, which can, for example, be manufactured as an articulated section or by means of a flexible, e.g., corrugated pipe-like, section. The coupling housing 1 here is preferably produced from a polymer or metallic material, which is partially selected adapted to the working conditions (temperature, mechanical loads) and media-resistance.

A multitude of possibilities are likewise conceivable for power transfer and diversion. For example, a multitude of materials and types of execution are already specified for the pull- and/or push-actuating device 10 by the claims. In particular, the variants given in the claims with the use of polymer or metallic materials or a corresponding hybrid design particularly present themselves for this. It is likewise also conceivable, instead of a plunger 10 with flexible plunger section 11, to execute the thrust diversion device 11 in the axial direction with a multitude of thrust sub-elements that can be brought into contact with one another, whereby these thrust sub-elements are essentially ring-shaped or toroid-shaped or essentially sphere-shaped or ellipsoid-shaped and have at least one flow channel 8 and/or bear ribs that allow flow around them and that are arranged in the circumferential area, and in this way transfer to the valve device the pushing pressure that is produced by the insertion of the line stubs without closing off the flow channel 8. By means of sliding and/or protective coatings, the range of applications here for materials useful for the pull- and/or push-actuating device 10 can be increased by, for example, making it possible to improve the media-resistance and/or sliding characteristics.

In addition to the three-blade plunger design made from a flexible, media-resistant plastic and mentioned in the first embodiment, the pull- and/or push-actuating device 10 can, depending on the application requirements and specifications, also have a hose-like element through the inside of which a medium can flow, e.g., a plastic hose, that can have transversally running cuts in order to increase flexibility, said cuts preferably running from an envelope line or two diametrically opposed envelope lines to the centre line and preferably being executed as V-shaped notches, as a result of which the flexibility can be considerably increased. In the case of V-shaped notches cut into the inner side of the curves, a design of this type simultaneously allows the bending radius to be limited in the minimum direction because the notch flanks of the V-shaped sections limit the bending of the flexible plunger section 11 to that radius of curvature at which the notch flanks hit against one another. Also conceivable as another execution variant for use as a pull- and/or push-actuating device 10 would be a worm-screw-like element, preferably made of a metallic or polymer material and having a very high level of flexibility while simultaneously being able to transfer the pushing force effectively when its coils support one another when under pressure. Such a worm-screw-like element can function in this case as a pressure transfer device 10 on its own, or in connection, for example, with an interior, e.g., hose-shaped or profiled, plunger element.

It would likewise be conceivable, e.g., to assign to a hose element functioning as a pull- and/or push-actuating device 10, spacing elements for stabilisation, e.g., in the form of metallic rings spaced some distance from one another, that stabilise these hose elements and that, in a similar manner, can, like the aforementioned V-shaped cuts, restrict the bending to that bending radius at which the metal rings come into contact with one another on the inner side of the curve.

For certain application cases, it can be expedient to stabilise the pull- and/or push-actuating device 10 within the flow channel by means of supporting devices 12 which are supported on the inner wall of the flow channel 8 of the coupling housing 1, in order to prevent evading movement of the pull- and/or push-actuating device 10, e.g., when pressure is exerted. In this case, sliding elements, e.g., such as sliding rings that can be slid on to the pull- and/or push-actuating device 10, would be conceivable. Likewise, it is also possible either to provide the pull- and/or push-actuating device 10 and/or the inner wall of the hollow space section of the flow channel 8 of the coupling housing 1 that encloses the pull- and/or push-actuating device 10 with sliding elements, sliding spacing elements or sliding guide elements, as a result of which it is possible to achieve friction reduction, a spacing function, path limitation and/or rotary protection. Such sections can, e.g., be executed in the axial direction as continuous or interrupted ribs or blades and also be run in the complementary grooves provided for them on the respective other component.

The aforementioned locating ring 9 is not obligatory in every case, but is usually advantageous and serves as wear protection and the secure pressure transfer between the line stub 2 and the pull- and/or push-actuating device 10. The stopping element 9 here should form the most secure contact possible with the line stub 2 and simultaneously impair the flow path from the line stub 2 in the flow channel as little as possible. The stopping element 9 is advantageously also adapted to the design of the pull- and/or push-actuating device 10. This means that in the case of the previously described three-blade plunger 10, a stopping device 9, also equipped with three radial blades or ribs 21 and enclosed in the circumferential direction with a cylindrical stabilisation section could possibly be expedient. In the case of a hollow pull- and/or push-actuating device 10 through which a medium can flow, it can, on the other hand, be more advantageous to provide the stopping device 9 with a large axial central opening that is arranged to be aligned with the hollow pull- and/or push-actuating device 10. Like the pull- and/or push-actuating device 10, the stopping device 9 can also additionally be provided with sliding and/or guiding sections on the outer circumference in a similar manner.

In another variant of the valve device, it can be expedient to replace the compression spring 14 with a tension spring, e.g., when the pull- and/or push-actuating device 10 is provided exclusively for pressure transfer or is unsuitable for transferring tensile forces and therefore should not or cannot be used for pulling the valve body 17 back into the valve seat 15.

In the other variant, the coupling device with the valve device does not end in a (terminal) valve section 18, but instead the valve device is arranged in the middle of a longer line device.

For certain other application requirements, a variant of the coupling device with valve device in which the valve device is physically arranged at a great distance from the connection section 4 can be expedient. Consequently, it would, e.g., be conceivable to equip a fuel line with such a coupling device in which the blocking point is arranged shifted away from the engine compartment and on the tank side, as a result of which safety advantages in the case of an accident or engine compartment fire and space advantages for the design can result, with the possibility of optimising the flow resistance of the valve unit. With regard to the aforementioned safety aspects, it would be conceivable to produce a coupling device with relocated valve unit by means of the geometric structuring of coupling device and line course or by the choice of materials and possibly also predetermined breaking points, whereby in the case of an accident or engine compartment fire, said valve device performs a deformation-caused or temperature-caused self-closure and so interrupts the fuel supply.

1-38. (canceled)

39. Valve device, preferably for a line device or connecting device, with a valve body that can be transferred from an open position to a closed position, wherein the valve body comprises movable sectored devices which have sealing edges or sealing surfaces via which, in a closed position, a sealing contact of the sectored device to adjoining sealing edges or sealing surfaces can be established, and these sectored devices can at least be in sections moved in the radial direction away from the centre axis when the valve body is transferred to the open position and release a flow area, wherein the sectored devices can be moved in the axial direction relative to a valve seat, wherein the sectored devices can be moved radially towards one another and closed by being slid against the valve seat and can be opened by being moved away from the valve seat.

40. Valve device according to claim 39, wherein a sealing contact between the sealing edges or sealing surfaces of adjoining sectored devices can be established in the closed state and the sealing edges or sealing surfaces that lie against one another in the closed state and that belong to adjacent sectored devices can be at least in sections moved away from one another in the circumferential direction when the valve body is transferred to the open position.

41. Valve device according to claim 39, wherein the valve body with a plurality of sectored devices can be brought to lie against an outer contour of the valve body with the valve seat in such a manner as to form a seal in the closed state.

42. Valve device according to claim 39, wherein the valve body is hollow, wherein the valve body, when closed, forms a closed hollow form in the direction of an opening end, said hollow form having an opening in the direction of the non-opening end of the valve body, and the sectored devices of said valve body forming sealing edges via which a sealing contact can be established between the sectored devices in the closed state.

43. Valve device according to claim 39, wherein the sectored devices can be transferred from the open position to the closed position by means of an actuating device.

44. Valve device according to claim 39, wherein the actuating device is mechanically connected at least in sections to the sectored devices.

45. Valve device according to claim 39, wherein the actuating device is mechanically unconnected to the sectored devices and can be moved relative to the sectored devices in the axial direction.

46. Valve device according to claim 39, wherein the sectored devices of the valve body can be closed by pulling the valve body into the valve seat.

47. Valve device according to claim 39, wherein the valve body can be connected to a pull- and/or push-actuating device by means of which the valve body can be moved relative to the valve seat.

48. Valve device according to claim 39, wherein the valve body has a plurality of flat surface elements on its outer side.

49. Valve device according to claim 39, wherein the valve body has conical-envelope-sector-shaped or truncated conical-envelope-sector-shaped sub-areas on its outer side.

50. Valve device according to claim 39, wherein the valve body has ellipsoid, paraboloid or hyperboloid sub-areas on its outer side.

51. Valve device according to claim 39, wherein the closed valve body has two conical structures with the same base and connected to each another at the bases, whose one conical structure, arranged in the direction of the opening end, corresponds in its outer shape to a conical envelope and whose other conical structure, arranged in the direction of the non-opening end, corresponds in its outer shape to a truncated conical envelope and wherein the closed valve body is circular in the transversal cutting plane.

52. Valve device according to claim 39, wherein the closed valve body has two pyramid structures with the same base and connected to one another at the bases, whose one pyramid structure, arranged in the direction of the opening end, corresponds in its outer shape to a pyramid envelope and whose other pyramid structure, arranged in the direction of the non-opening end, corresponds in its outer shape to a truncated pyramid envelope and wherein the closed valve body forms a regular polygon in the transversal cutting plane.

53. Valve device according to claim 39, wherein the closed valve body has sectored devices that can open in the radial direction at least at the closed pointed end of the pyramid vertex of the pyramid lying in the direction of the opening end, wherein these sectored devices form sealing edges which embrace at least the outer edges of the pyramid arranged in the direction of the opening end.

54. Valve device according to claim 39, wherein the pyramid structures are constructed from straight, three-dimensional simplices or tetrahedrons and form an equilateral triangle in the transversal cutting plane.

55. Valve device according to claim 39, wherein the rotationally-symmetrical or polyhedric, axially-symmetrical valve body has a transversal equatorial plane in which its transversal cut forms a maximum area from which the valve body tapers essentially conically in the closing direction.

56. Valve device according to claim 39, wherein the valve body circumscribes a circle in the transversal equatorial plane in which its transversal cut has a maximum area, wherein the valve body tapers essentially conically in the closing direction and transforms into a polygon in the transversal cutting plane from this circle.

57. Valve device according to claim 39, wherein the valve body has an odd number of sectored devices, preferably three sectored devices, and that these form equal sector angles, preferably 120° angles, from the centre axis outwards.

58. Valve device according to claim 39, wherein the valve body comprises at least one base element to which the sectored devices are linked.

59. Valve device according to claim 39, wherein the sectored devices are connected to the base element of the valve body by means of hinges, preferable foil hinges, or bending sections and the valve body is preferably formed as a single piece.

60. Valve device according to claim 39, wherein the valve body has different materials in different sections, and preferably can be manufactured in a multi-component moulding procedure.

61. Valve device according to claim 39, wherein the valve body has a material in the linkage and bending area of the sectored devices that has greater elasticity and/or a lower modulus of elasticity than at the adjacent areas of the valve body.

62. Valve device according to claim 39, wherein the valve body has a sealing material in the area of the sealing edges of the sectored devices.

63. Valve device according to claim 39, wherein the valve body has a sealing material in the valve seat area of the sectored devices.

64. Valve device according to claim 39, wherein the sectored devices are pre-tensed in the open position.

65. Valve device according to claim 39, wherein the bending sections preferably have a three-dimensional form, wherein the material elasticity can be used for pre-tensing the sectored devices.

66. Valve device according to claim 39, wherein the pull- and/or push-actuating device has spring-like elastic characteristics and is provided for the purpose of acting upon the valve body in the closing direction of the same with a restoring force and for transferring the valve body from the open position to the closed position when the end section of the line device or the second connecting device is removed from the connecting area of the valve housing.

67. Valve device according to claim 39, wherein the valve device comprises a restoring device which acts upon the valve body in the closing direction of the same with a restoring force and is provided for transferring the valve body from the open position to the closed position.

68. Valve device according to claim 39, wherein the restoring device has a coil spring.

69. Valve device according to claim 39, wherein the restoring device is a tension spring.

70. Valve device according to claim 39, wherein the coil spring is arranged within the flow channel of the housing enclosing at least sections of the pull- and/or push-actuating device, between the inner wall of the housing and the pull- and/or push-actuating device.

71. Valve device according to claim 39, wherein the coil spring is a compression spring and can be spanned between a stopping element mechanically connected to the pull- and/or push-actuating device and a housing-side support lying axially at a distance to this stopping element and closer to the valve body with respect to this stopping element in the flow direction, wherein the valve body can be transferred to the closed position by a stroke via the pull- and/or push-actuating device and the compression spring can be pressure loaded when the valve is transferred to the closed position.

72. Valve device according to claim 39, wherein the housing-side support of the compression spring is arranged adjacent to the valve seat.

73. Valve device according to claim 39, wherein the valve body is surrounded by a protective sleeve in the radial direction.

74. Valve device according to claim 39, wherein the protective sleeve essentially completely surrounds the valve body at least in its closed state in the radial direction.

75. Valve device according to claim 39, wherein the protective sleeve can be undetachably connected to the valve housing and preferably is formed with the valve housing as a single piece.
